(19) United States
(12) Patent Application Publication
(10) Pub. No.: US 2024/0068726 A1
(43) Pub. Date: Feb. 29, 2024

(54) ABSORPTION COOLING MACHINE

(71) Applicant: Ecoclim SA, Sion (CH)

(72) Inventor: Vitale Bruzzo, Padua (IT)

(73) Assignee: Ecoclim SA, Sion (CH)

(21) Appl. No.: 17/767,456

(22) PCT Filed: Oct. 7, 2020
(86) PCT No.: PCT/IB2020/059408

§ 371 Date: Apr. 8, 2022

(30) Foreign Application Priority Data
Oct. 9, 2019 (CH) 01291/19

(51) Int. Cl. F25B 41/00; F25B 17/08; F25B 49/04

(52) U.S. Cl. CPC F25B 41/00; F25B 17/08; F25B 49/046; F25B 2500/05

(57) ABSTRACT

The present invention relates to a machine for cooling by absorption, comprising a desorber/condenser assembly comprising a refrigerant and absorbent desorber, a refrigerant condenser and an evaporator/absorber assembly. The machine comprises a first pump designed to recover a solution from the absorber, a second pump designed to recover the refrigerant from the evaporator, and a third pump designed to recover a weakened solution from the absorber and pass it through a third exchanger in which the weak solution is heated before being directed toward a fourth exchanger where the weak solution continues to be heated before being directed towards the desorber. The first exchanger is arranged between the first pump and the absorber gratings and is configured to form a siphon for the absorbent, thus preventing the passage of air, the machine having no electric valve.

The present invention relates to an absorption cooling machine comprising means for reducing energy consumption and increasing efficiency.

Absorption machines are very widespread thermal cooling systems.

Absorption machines work by virtue of the ability of certain liquids to absorb and desorb a vapor. The mixture of these two bodies is called a binary mixture. By positioning them adjacent to one another, the one that evaporates cools down while the one that absorbs heats up, in an exothermic process. The constituent that absorbs is called the absorbent, while the constituent that desorbs, and is highly volatile, is the refrigerant or the evaporant.

Two couples are mainly used even though other solutions exist as they are too expensive, too complicated or too polluting. The first is the water-and-ammonia (NH3) solution, where water is the absorbent and ammonia is the evaporant. This solution allows cooling down to −24° Celsius with heating of 160° Celsius and pressures of up to 20 atmospheres. The second solution is the water-and-lithium bromide (H2O—LiBr) mixture, water being the evaporant and the lithium bromide the absorbent. With the latter it is possible to cool down to 1° Celsius with heating (in the machines currently in operation) of 90° Celsius, at pressures between 6 mb and 85 mb (vacuum).

This solution is based on the triple point of water; at about 6 mb and a temperature of 0° Celsius, water is solid, liquid, and gaseous (vapor). In other words, at a pressure of 6 mb, water boils at 0° Celsius.

Therefore, just maintaining water at 6 mb keeps it at 0°. The pressure we live in is 1010 mb on average. It is therefore necessary to work in a vacuum. Researchers such as William Cullen in 1755, Gerald Nairme in 1777, John Leslie in 1810, and the Frenchmen Edmond and Ferdinand Cane in 1859 arrived at this, as a result of which the principle of cooling by absorption is widespread today.

EP1210556 describes a system for producing cold by absorption comprising a generator, a condenser, an evaporator, an expansion valve and an absorber, and a pressurized refrigerant storage assembly comprising at least one tank, a valve upstream of said tank and a valve downstream of said tank. The upstream valve is opened when the pressure at the outlet of the condenser is higher than or equal to the pressure in the tank and the downstream valve is closed when the generator stops producing vapor.

In addition, the applicant has refined the system by absorption to the point of today being able to produce cold using solar energy or even hot water from a motor vehicle, that is to say with free energy.

The object of the present invention is therefore to provide an absorption cooling system that has the advantage of providing much higher efficiencies than conventional systems and whose construction is simplified.

By virtue of the machine of the present invention, it is possible to produce intense cold, even at full speed, with water heated between 60° Celsius and 75° Celsius, unlike machines on the market which operate at 90° Celsius.

In accordance with the invention, an absorption cooling machine comprises a desorber/condenser assembly comprising a refrigerant and absorbent desorber by separation of a mixed flow, and a refrigerant condenser connected to the desorber. The machine comprises an evaporator/absorber assembly, the refrigerant absorber being arranged so as to absorb the evaporated refrigerant coming from the evaporator, the absorber being connected to the condenser by an absorbent supply line and a mixed fluid discharge line. The machine further comprises a first pump designed to recover a solution from the absorber and send it through a first exchanger where the solution is cooled before being directed toward gratings of the absorber, a second pump designed to recover the refrigerant from the evaporator and send it through a second exchanger where it cools the refrigerant, before directing it to the gratings of the evaporator, and a third pump designed to recover a depleted solution from the absorber and send it to a third exchanger in which the depleted solution is heated before being directed to a fourth exchanger where the depleted solution continues to be heated before being directed to the desorber. The machine also comprises a circuit board designed to control the amperage of the pumps and stop the heating if the amperage reaches a critical threshold, typically 1.8 A. The first exchanger is arranged between the first pump and the absorber gratings and is configured to form a siphon for the absorbent, thus preventing the passage of air, the machine having no electromagnetic valve.

The features of the invention will become more clearly apparent from reading a description of one embodiment given solely by way of entirely non-limiting example with reference to the schematic figures, in which:

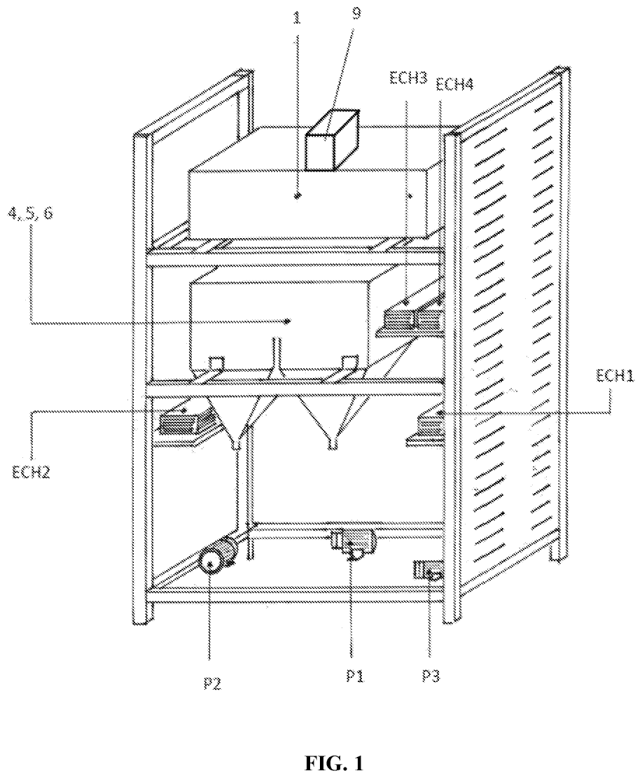

FIG. 1 shows an absorption machine whose protective cover has been removed;

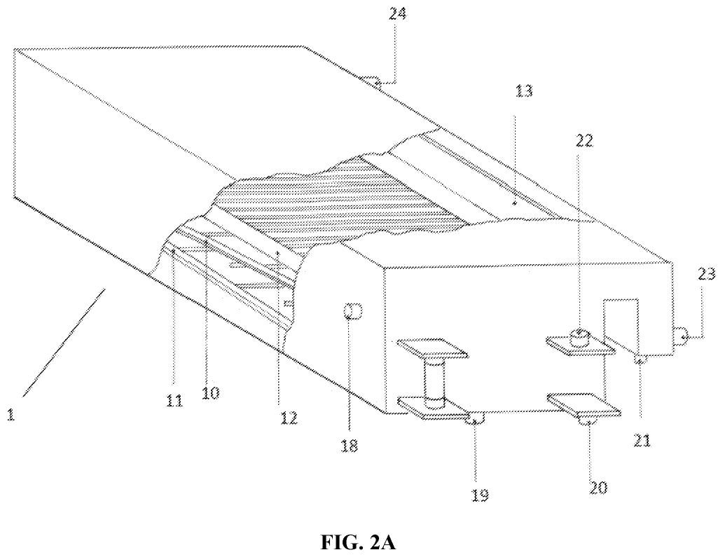

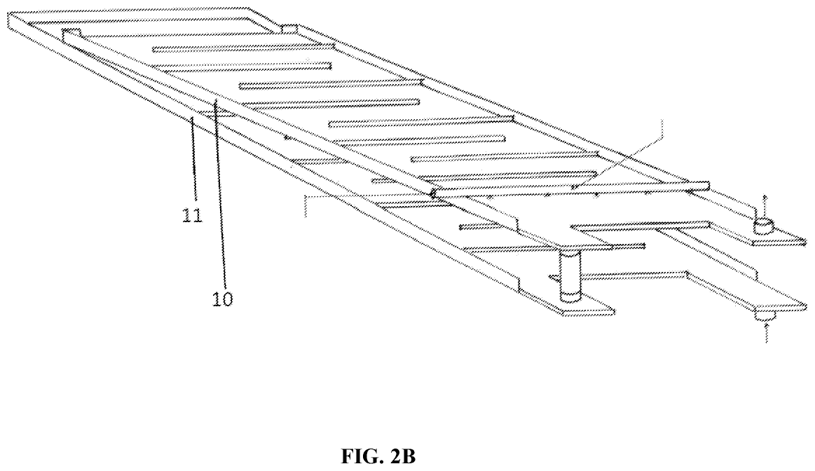

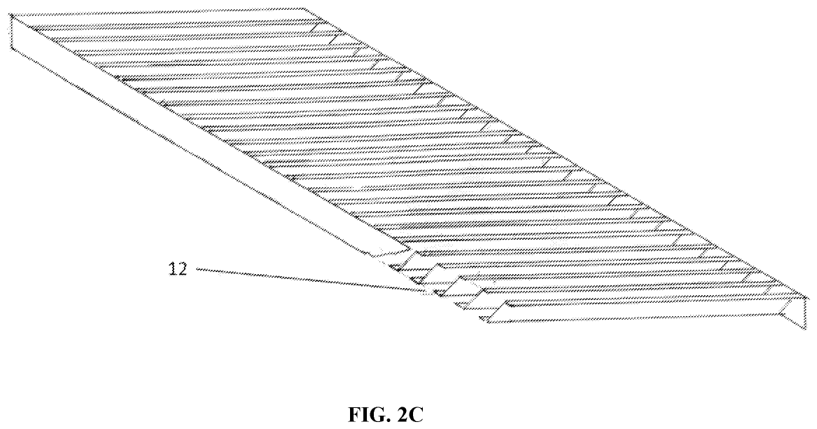

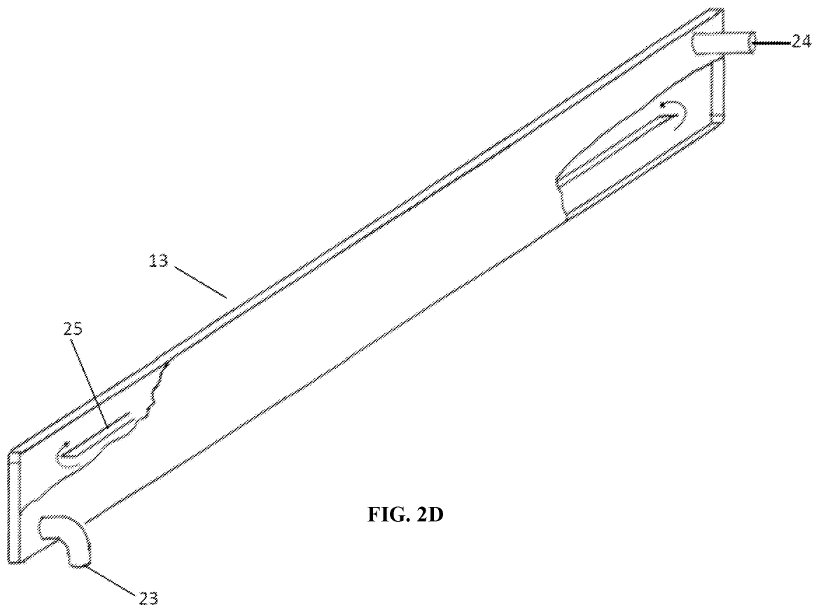

FIG. 2A shows a partially cut-away perspective view of the desorber/condenser assembly of the machine of FIG. 1;

FIG. 2B shows a perspective view of two plates of the desorber/condenser assembly of FIG. 2A;

FIG. 2C shows a partial view of a splash plate of the desorber/condenser assembly of FIG. 2A;

FIG. 2D shows a partially cut-away view of a condenser of the desorber/condenser assembly of FIG. 2A;

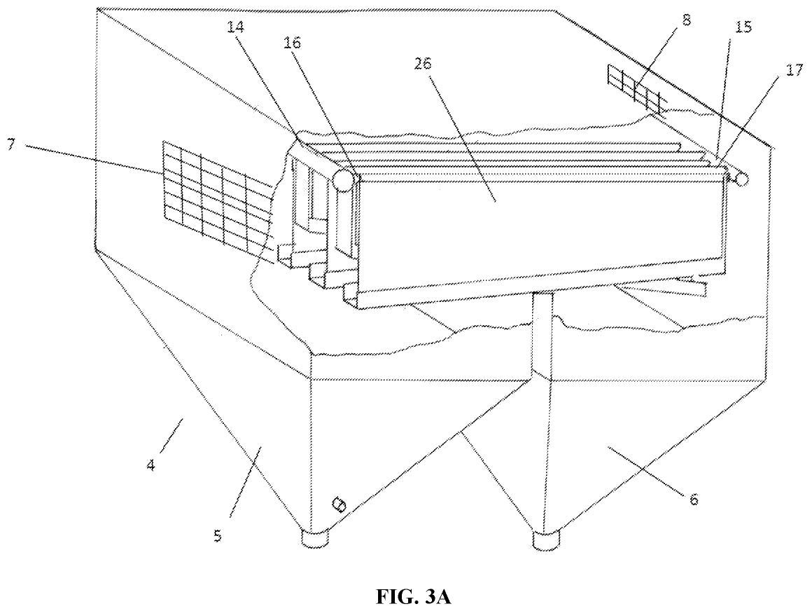

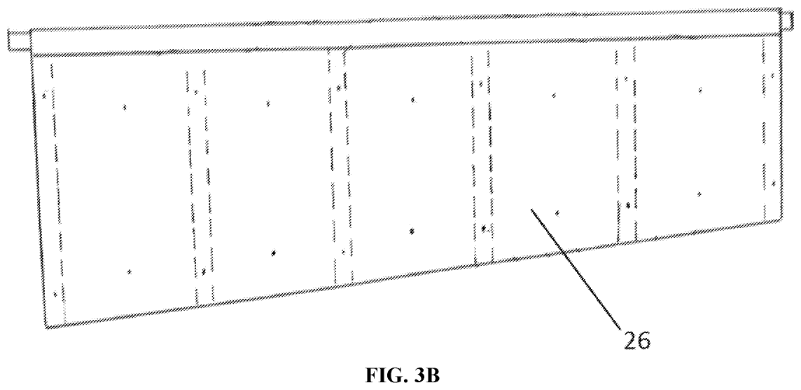

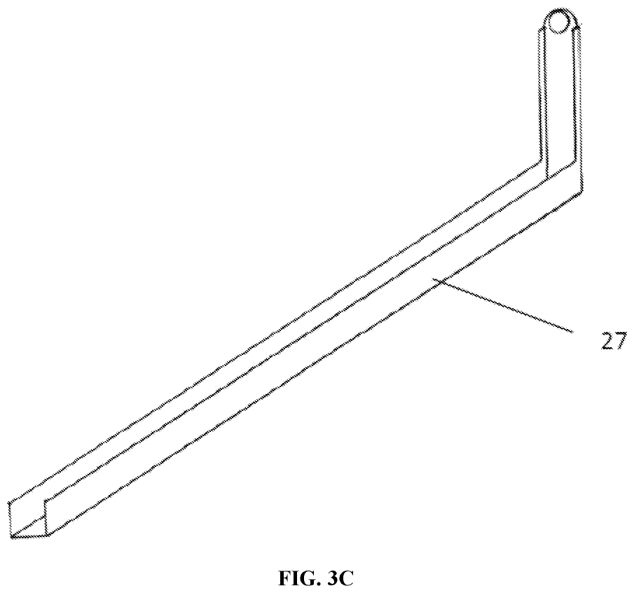

FIG. 3A shows a perspective view of the evaporator/absorber assembly of FIG. 1;

FIG. 3B shows a side view of a grating of the evaporator/absorber assembly of FIG. 3A;

FIG. 3C shows a perspective view of a channel for receiving liquid from the gratings of the evaporator/absorber assembly of FIG. 3A; and

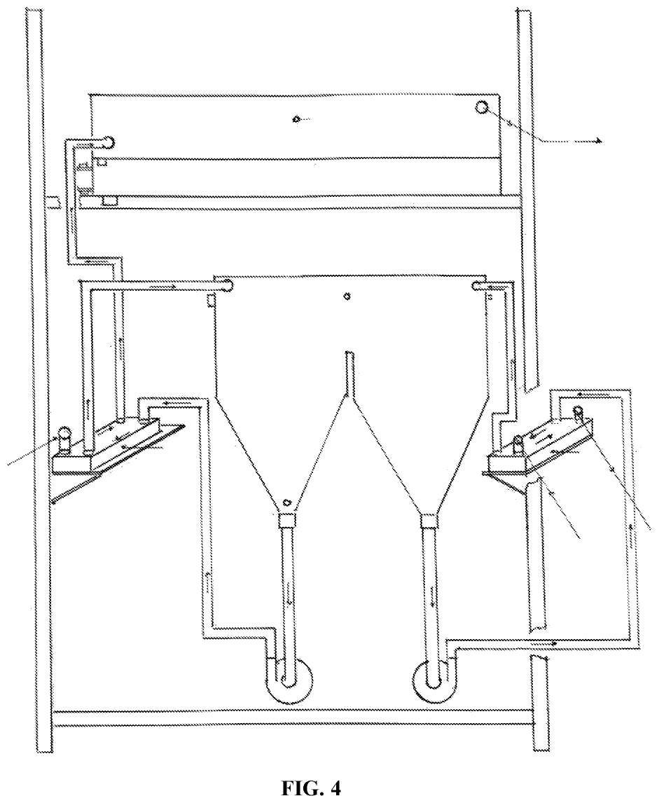

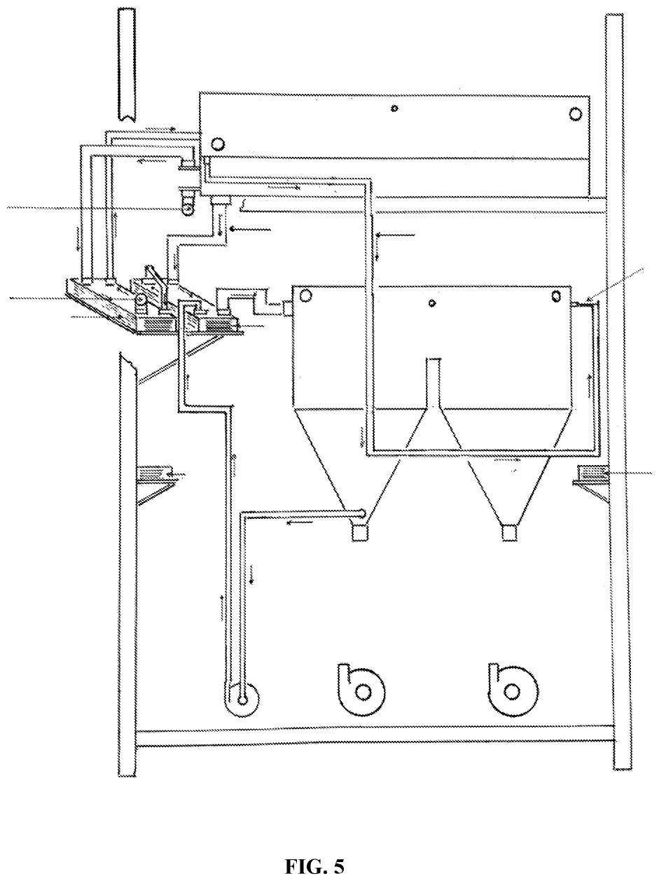

FIGS. 4 and 5 shows a schematic view of the rear of the machine according to the present invention.

According to the preferred embodiment of the invention as illustrated in FIG. 1, the absorption cooling machine uses a mixed fluid composed of lithium bromide as the absorbent and water as the refrigerant. The absorption cooling machine comprises a desorber/condenser assembly 1 comprising a refrigerant and absorbent desorber 2 (FIG. 2A) by separation of a mixed flow, and a refrigerant condenser 3 (FIG. 2A) connected to the desorber 2. The machine comprises an evaporator/absorber assembly 4, the refrigerant absorber 5 being arranged so as to absorb the evaporated refrigerant coming from the evaporator 6, the absorber being connected to the condenser by an absorbent supply line and a mixed fluid discharge line.

The machine comprises a first pump P1 designed to recover a solution from the absorber 5 and send it through a first exchanger ECH1 where the solution is cooled before being directed to the gratings 7 (see FIG. 3A) of the absorber 5. It is the pump P1 which is magnetically driven and which sends the alert to a circuit board in the event of a solution that is too rich. The flow rate of this pump P1 is approximately equal to 1500 L/H.

A second pump P2 is designed to recover the cooled water from the evaporator 6 and send it through a second exchanger ECH2 where it cools the air-conditioning liquid, before directing this cooled water to gratings 8 (see FIG. 3A) of the evaporator. The flow rate of this pump P2 is approximately equal to 1500 L/H.

A third pump P3 is designed to recover a depleted solution from the absorber 5 and send it through a third exchanger ECH3 in which the depleted solution is heated before being directed to a fourth exchanger ECH4 where the depleted solution continues to be heated before being directed to the desorber 2.

A circuit board 9 (see FIG. 1) designed to control the amperage of the pumps P1, P2, P3 and stop the heating if the amperage reaches a critical threshold, typically 1.8 A. At the threshold value of 1.8 A, the circuit board triggers the stopping of the heating and switches off the pump. This prevents crystallization of the lithium bromide.

The first exchanger ECH1 is arranged between the first pump P1 and the gratings 7 of the absorber 5 and is configured to form a siphon for the absorbent, thus preventing the passage of air, the machine having no electromagnetic valve. The siphon is arranged in such a way as to avoid the control valves. Water-saturated lithium bromide is sent to the desorber/condenser assembly. The extra water evaporates in the condenser and goes back down to the evaporator. The lithium bromide that evaporated the extra water goes back down to the absorber. The pressure is 85 mbar in the desorber/condenser assembly and 10 mbar in the evaporator/absorber. The risk is that, without control, vapor comes as well as the water. The siphon is created for this purpose. The pressure difference of 75 mbar requires the creation of a 75 cm-long siphon. For example, with a pressure difference of 60 mbar, a siphon length of 60 cm would be sufficient. The siphon length is therefore proportional to the pressure difference between the desorber/condenser and the evaporator/absorber. By virtue of this device, it is possible to keep control of the water coming down from the condenser.

The first, second and third pumps P1, P2, P3 are magnetic drive pumps and the third pump P3 is a magnetic drive gear pump.

As illustrated in FIGS. 4 and 5, the third magnetic drive pump P3 is a gear pump. It provides a flow rate of 200 L/H in vacuum but remains at 200 L/H at 10 atm, thereby ensuring a high regularity of flow rate, which is advisable in the context of the present invention. The third magnetic drive pump P3 receives the depleted solution from the absorber, directs it to the third exchanger ECH3 in which it crosses the rich solution which descends from the desorber at a high temperature. Thus, the depleted solution is heated and the rich solution is cooled. At the outlet of the third exchanger ECH3, the depleted solution is directed to the fourth exchanger ECH4 where it crosses the heating water coming out of the desorber. It is subsequently heated and arrives in the desorber ready to desorb.

As illustrated in FIGS. 2A and 2B, the desorber/condenser assembly 1 comprises two desorption plates 10, 11 that are superposed and inclined with respect to one another, typically with a slope of approximately 4%, the flow area of the two plates 10, 11 being slightly greater than the area of an inlet connection 20 of the plates 10, 11, a splash plate 12 (see FIG. 2C) comprising slats that are flat and parallel with respect to one another, the slats being fixed together by long strips arranged on either side of each slat so as to let vapor through but stop droplets of the absorbent solution.

As illustrated in FIG. 2D, the desorber/condenser assembly 1 comprises a vertical condensation plate 13 of which a cooling water inlet 23 is positioned lower than a cooling water outlet 24, the flow area of the internal channels of the condenser being slightly greater than the area of an inlet connection. The condenser comprises small separation plates 25 serving to orient the direction of the flow.

As illustrated in FIG. 3A, the evaporator/absorber assembly 4 is connected to a circulation circuit for a binary mixture comprising a first, refrigerant fluid and a second, absorbent fluid, the refrigerant being evaporated in an evaporator portion of the evaporator/absorber assembly 4 and then absorbed in an absorber portion of the evaporator/absorber assembly 4 by the absorbent-rich mixture. The evaporator/absorber assembly 4 comprises two distributor tubes 14, 15 facing one another forming evaporator 6 and absorber 5 members, refrigerant diffusers 16 and absorbent-rich mixture diffusers 17, each refrigerant diffuser being arranged in alternation with an absorbent-rich mixture diffuser.

The evaporator comprises a plurality of gratings 26 (see FIG. 3B) and a channel 27 (see FIG. 3C) for receiving liquid from the gratings 26. The gratings 26 are arranged vertically in the evaporator/absorber assembly 4 in transversely spaced parallel planes. Each grating 26 extends from one edge of one distributor to another edge of the opposite distributor. Each grating 26 is engaged in the receiving channel 27 and secured in the middle thereof by weld spots. In this example, the water grating mesh is 14/100.200 while the lithium bromide grating mesh is 25/118.114.

Each receiving channel 27 of the evaporator/absorber assembly 4 allows selective recovery of the liquids by gravity.

Since the water molecule is smaller than that of lithium bromide, the gratings 26 of the evaporator are finer than the gratings 26 of the absorber, thereby allowing the liquid to be retained and the vapor to pass through.

At the inlet of the absorber and of the evaporator, another grating 7 and yet another grating 8 are arranged a few millimeters from the walls, for example 5 mm, so as to prevent splash of the rich solution or of the water when one, the lithium bromide, enters the absorber and the other, the water, enters the evaporator.

To produce around 10 kW/h of cold, it is necessary to evaporate, absorb, desorb and condense around 20 liters of water/hour. With 200 l/h of 56% solution (approximately 1620 gr/liter) being circulated between the absorber and the desorber, to produce 10 kW/h of cold, it is necessary to subtract approximately 20 liters of water (20,000 gr) from the (1620 gr×200 liters-324,000 gr) of 56% solution in circulation, therefore desorbing and condensing 20,000 gr of water.

Thus, at the outlet of the desorber there will be 324,000 gr-20,000 gr or 304,000 gr for 180 liters of solution.

That is to say a solution that will weigh 304,000 gr/180 liters=1688.80 gr/l or about 59% lithium bromide.

This is an ideal result.

By virtue of the machine of the present invention, this result is obtained with a temperature at the absorber of 30° and heating at the desorber of 75°. However, if the solution is above 35° at the absorber, to obtain a good result, the lithium bromide concentration must be 59%, i.e. approximately 1690 gr×200=338,000 gr of solution and it is necessary to desorb 20 l (20,000 gr) of water and get (338,000 gr-20,000 gr)/180 liters, that is to say a solution that will weigh 1766.67 gr/liter at about 63% concentration. In this configuration, the crystallization threshold is reached.

Crystallization is due to an overly high concentration of lithium bromide in the solution because the machine desorbs more than it absorbs. Generally, following excessive pressure in the evaporator due to a leak or the formation of non-condensables, the machine no longer evaporates, does not absorb and continues to desorb until failure.

The machine of the present invention solves this problem. It has been observed that the amperage of the pump for the solution increased by 2.5/10 when the solution went from 54% to 61% so that when the amperage increases beyond 2.5/10 the heating is automatically stopped and triggers the alert, thereby avoiding crystallization. By way of example, the amperage has a value of 1.5 A at 54%, 1.6 A at 58%, and 1.75 A at 60%.

Flow control is important. The water and lithium bromide must never flow at more than 5 km/h. At 54% the solution weighs about 1600 gr/liter, its fluidity is not ideal and as the concentration increases, fluidity decreases with crystallization occurring at 65%. Thus, to prevent crystallization, a flow rate of approximately 1500 l/h of water from ½″ tubes (12.7 mm internal diameter) is sufficient. With the same flow rate for the solution, it will be necessary to use ¾″ tubes (19.5 mm internal diameter).

The machine of the present invention is designed to operate both with solar energy and with a standard electrical network. Its operation is simplified insofar as all electromagnetic valves are eliminated by virtue of the use of siphons.

By virtue of the machine of the present invention, it is possible to produce intense cold with heated water without bringing it to the boil, that is to say from a temperature of around 60°, which in particular facilitates the operation of the machine with solar energy.

What is claimed is:

1. An absorption cooling machine comprising:
a desorber/condenser assembly (1) comprising:
a refrigerant and absorbent desorber (2) by separation of a mixed flow;
a refrigerant condenser (3) connected to the desorber (2);
an evaporator/absorber assembly (4), the refrigerant absorber (5) being arranged so as to absorb the evaporated refrigerant coming from the evaporator (6), the absorber (5) being connected to the condenser (3) by an absorbent supply line and a mixed fluid discharge line,
a first pump (P1) designed to recover a solution from the absorber (5) and send it through a first exchanger (ECH1) where the solution is cooled before being directed to the gratings (7) of the absorber (5),
a second pump (P2) designed to recover the refrigerant from the evaporator (6) and send it through a second exchanger (ECH2) where it cools said refrigerant, before directing it to the gratings (8) of the evaporator (6),
a third pump (P3) designed to recover a depleted solution from the absorber (5) and send it through a third exchanger (ECH3) in which the depleted solution is heated before being directed to a fourth exchanger (ECH4) where the depleted solution continues to be heated before being directed to the desorber (2),
a circuit board (9) designed to control the amperage of the pumps (P1, P2, P3) and stop the heating if the amperage reaches a critical threshold, typically 1.8 A,
wherein the first exchanger (ECH1) is arranged between the first pump (P1) and the gratings (7) of the absorber (5) and is configured to form a siphon for the absorbent, thus preventing the passage of air, the machine having no electromagnetic valve.

2. The cooling machine as claimed in claim 1, wherein the first, second and third pumps (P1, P2, P3) are magnetic drive pumps and the third pump (P3) is a magnetic drive gear pump.

3. The cooling machine as claimed in claim 1, wherein the desorber/condenser assembly (1) comprises two desorption plates (10, 11) that are superposed and inclined with respect to one another, typically with a slope of approximately 4%, the flow area of internal channels of the two plates (10, 11) being slightly greater than the area of an inlet connection of the plates (10, 11) allowing the passage of a fluid, a splash plate (12) comprising slats that are flat and parallel with respect to one another, the slats being fixed together by long strips arranged on either side of each slat so as to let vapor pass through but stop droplets of the absorbent solution.

4. The cooling machine as claimed in claim 1, wherein the desorber/condenser assembly (1) comprises a vertical condensation plate (13) of which a cooling water inlet is positioned lower than a cooling water outlet, the flow area of the internal channels of the condenser being slightly greater than the area of an inlet connection.

5. The cooling machine as claimed in claim 1, wherein the evaporator/absorber assembly (4) is connected to a circulation circuit for a binary mixture comprising a first, refrigerant fluid and a second, absorbent fluid, the refrigerant being evaporated in an evaporator portion of the evaporator/absorber assembly (4) and then absorbed in an absorber portion of the evaporator/absorber assembly (4) by the absorbent-rich mixture.

6. The cooling machine as claimed in claim 5, wherein the evaporator/absorber assembly (4) comprises two distributor tubes (14, 15) facing one another forming evaporator (6) and absorber (5) members, refrigerant diffusers (16) and absorbent-rich mixture diffusers (17), each refrigerant diffuser being arranged in alternation with an absorbent-rich mixture diffuser.

7. The cooling machine as claimed in claim 1, wherein the refrigerant is water and the absorbent is lithium bromide.

8. The cooling machine as claimed in claim 1, wherein the evaporator (6) comprises a plurality of gratings (26) arranged vertically in the evaporator/absorber assembly (4) in transversely spaced parallel planes.

9. The cooling machine as claimed in claim 8, wherein each grating (26) is engaged in a receiving channel (27) secured in the middle thereof by weld spots, each receiving channel (27) being designed to recover the liquids by gravity.

10. The cooling machine as claimed in claim 8, wherein the gratings (26) of the evaporator are finer than the gratings (26) of the absorber, thereby allowing the liquid to be retained and the vapor to pass through, typically with a mesh of 14/100.200 for the evaporator gratings, and with a mesh of 25/118.114 for the absorber gratings.

11. The cooling machine as claimed in claim 8, wherein at the inlet of the absorber and of the evaporator, another grating (7) and yet another grating (8) are arranged a few millimeters from the walls, transversely to the gratings (26) of the evaporator and of the absorber, so as to prevent splash of the solutions when one enters the absorber and the other enters the evaporator.
